(19) United States
(12) Patent Application Publication
(10) Pub. No.: US 2007/0076880 A1
(43) Pub. Date: Apr. 5, 2007

(54) Secure digital transmission

(76) Inventor: Roman Kresina, Oxford, CT (US)

Correspondence Address: KENYON & KENYON LLP, 1500 K STREET N.W., SUITE 700, WASHINGTON, DC, 20005, US

(21) Appl. No.: 11/242,963

(22) Filed: Oct. 4, 2005

(51) Int. Cl. H04K 1/00

(52) U.S. Cl. 380/255

(57) ABSTRACT

A cryptographic device comprises a memory pre-programmed with cryptographic key, a data processor connected to the memory, and an interface for connecting the interface to a computer.

### BACKGROUND

1. Field

The present invention relates digital cryptography and, more particularly, to cryptographic hardware devices.

2. Brief Description of Related Developments

Various techniques are known for encrypting and decrypting digital messages, as well as for authenticating of digital messages with the use of digital signatures. A lack of security in the transmission of email has led to wide use of these techniques, with the goal of keeping transmitted information private. Known digital cryptographic and digital signature systems require the use of cryptographic keys, which are used to encipher and decipher information. Therefore, although digital cryptography allows secure transmission of messages over non-secure networks, a problem remains in how to distribute the cryptographic keys in a secure fashion. The development of public-key cryptography has provided a partial solution. It uses a public key to encipher information and a private key to decipher the information, where the private key is extremely difficult to compute from the public key. This way, a sender may use a broadly distributed public key to encipher a message and may then transmit the encrypted message over an insecure network. If the message is intercepted, it cannot be deciphered without the private key. Thus, only the intended recipient should be able to decipher the message, as only he has the private key. However, for a public-key encryption system to function in a secure manner, some means of authenticating the public key is required. Otherwise, there exists the possibility that one may falsely represent an interceptor's public key as that of the recipient. Then, when the enciphered message is intercepted, it may be decoded with the interceptor's private key. This is possible as the message was enciphered with the interceptor's public key, falsely represented as the public key of the intended recipient. Therefore, a secure technique for distributing cryptographic keys may be desirable.

### SUMMARY

In one embodiment of the present invention, a cryptographic device comprises a memory pre-programmed with a cryptographic key. The device further comprises a data processor connected to the memory for deciphering data with the cryptographic key, and also comprises n interface for connecting the data processor to a computer.

In another embodiment of the present invention, a method for distributing private keys for use in a public cryptographic system comprises generating an asymmetric key pair comprising a public cryptographic key and a private cryptographic key. The method further comprises storing the private cryptographic key on a portable hardware device wherein the portable hardware device comprises a memory for storing the private cryptographic key, a decryption unit for decrypting data with the private cryptographic key, and a physical data connector for connecting the device to a computer. The method further comprises sending the portable hardware device, with the private cryptographic key stored thereon, to an intended recipient of the encrypted message. The method also comprises encrypting the data with the public cryptographic key, and transmitting the encrypted data to the portable hardware device for decryption of the data by the device.

### BRIEF DESCRIPTION OF THE DRAWINGS

The foregoing aspects and other features of the present invention are explained in the following description, taken in connection with the accompanying drawings, wherein:

FIG. 1 is a block schematic diagram of a computer system incorporating aspects of the present invention;

FIG. 2 is a block schematic diagram of hardware device of FIG. 1, incorporating aspects of the present invention;

FIG. 3 is a flow diagram illustrating aspects of the present invention;

FIG. 4 is another flow diagram illustrating aspects of the present invention; and

FIG. 5 is yet another flow diagram illustrating aspects of the present invention.

### DETAILED DESCRIPTION

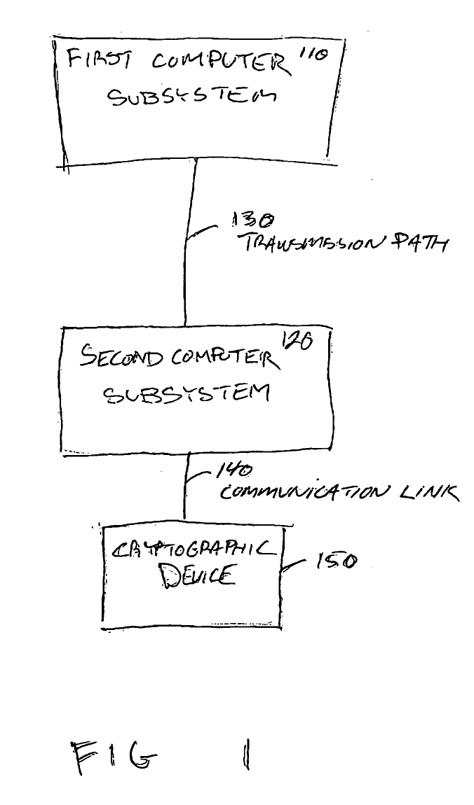

FIG. 1 shows a computer system that may use digital encryption and digital signatures. A first computer subsystem 110 is connected to a second computer subsystem 120 by a transmission path 130. First computer subsystem 110 and second computer subsystem 120 may be operated by different entities. The entities may have some business relation ship between them. For example, subsystem 110 may be operated by a bank, while subsystem 120 may be operated by a customer of the bank, such as an account holder. However, it is not necessary that there be such a relationship or even that there be separate entities. The transmission path 110 may be a computer network, such as the internet or other TCP/IP based network. The transmission path could also be a telephone system, a dedicated line, a physically transferred optical disk, or any other facility for transferring electronic data between first computer subsystem 110 and second computer subsystem 120. Transmission path 110 may be an at least somewhat insecure system. That is, it may be possible for a third party to intercept a message. The internet as well as corporate email systems typically present ample opportunities for intercepting and copying messages, or for creating false messages purporting to be from someone other than the actual sender. This may be done using computer software or even by tapping the physical layer of electrical or optical cable.

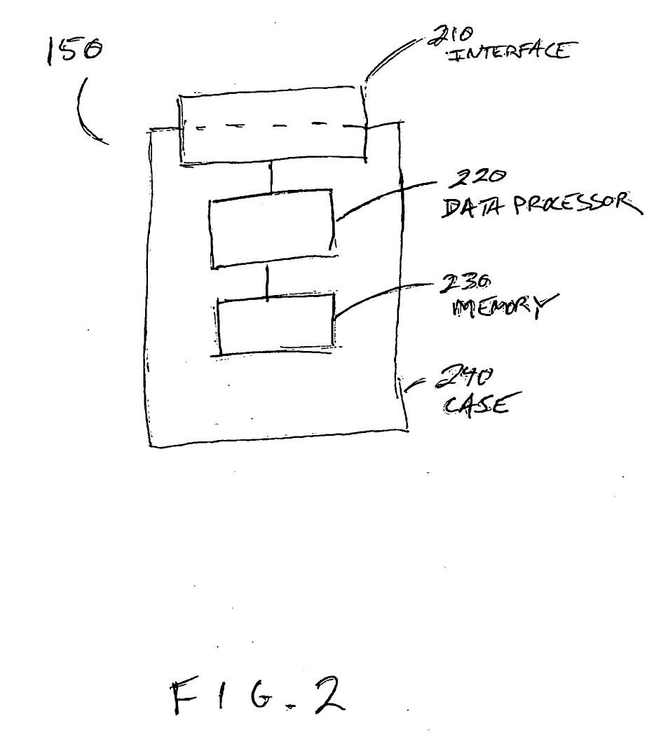

To achieve security of messaging over insecure transmission paths, digital cryptography may be used. FIG. 1 shows a digital cryptographic device 150 which is connected to the second computer subsystem 120 by a communications link 140. Communications link 140 may be an internal component of computer subsystem 120, an external wire, a wireless link, or any other suitable link. FIG. 2 illustrates cryptographic device 150 in more detail. As shown, the device 150 has an interface 210 for connecting the device to computer subsystem 120. The interface is connected to a data processor 220, which n turn is connected to a memory 230. Memory 230 may be a resilient memory which does not require a power source to maintain data. In other embodiments, a power supply such as a battery may be provided on the device 150 for maintaining stored data.

In an exemplary embodiment of the present invention, interface 210 may be a USB connector and a case 240 may house the data processor 220 and memory 230. The case 240 may be small enough to make the device 150. For example, device 150 may be made small enough to be kept on a key ring or in one's pocket. In another exemplary embodiment of the present invention, device 150 may be a smart card that is roughly or the same width and length of a standard business card, and interface 210 may be a smart card interface comprising electrical contacts for connecting to a smart card reader. In yet another embodiment, interface 210 may be a wireless interface. As unencrypted data may be sent through the interface 210, such a wireless interface may operate at low power, with high directionality, or in a secure environment, to prevent interception of the messages.

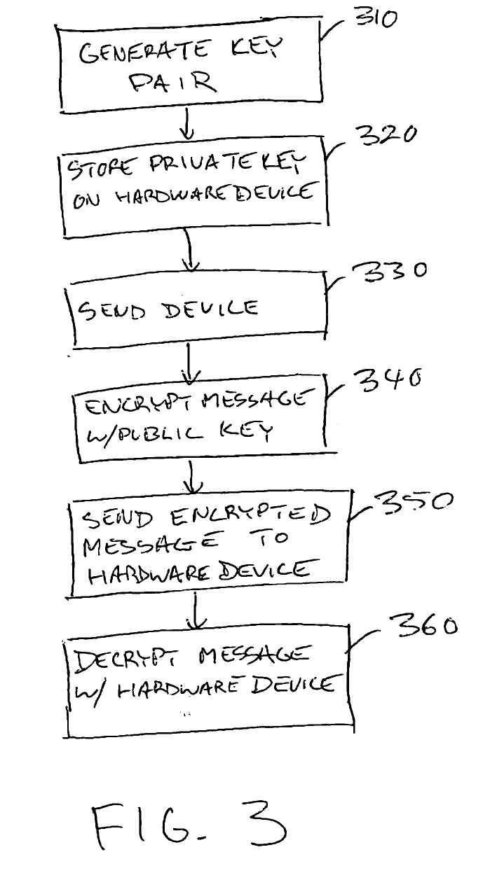

FIG. 3 illustrates a cryptographic method incorporating aspects of the present invention. In an exemplary embodiment, a form of two factor asymmetric cryptography is used. However, any suitable cryptographic technique using secret keys or algorithms may be used with the present invention. In step 310 of the exemplary embodiment, an asymmetric key pair is generated, the key comprising a public cryptographic key as well as a private cryptographic key. The two keys are related such that a message enciphered with the public key may only be deciphered using the private key. In the exemplary embodiment, there is also a reverse property that a message enciphered with the private key can be deciphered with the public key, this property having utility for digital signatures as will be described below. The two keys are related mathematically in such a way as it is extremely difficult to compute the private key from the public key. Thus, the public key of a recipient may be broadly distributed, allowing many parties to encipher messages for the recipient. However, the private key is closely guarded and perhaps may be possessed only by the recipient. Thus, if a message enciphered with the public key is intercepted by a third party who does not possess the private key, he will not be able to decipher the message.

Generation of the key pair may be done by the operator of the first computer system 110, but could be done by some other party. In step 320, the private key that has been generated in step 310 is stored on hardware device 150. In step 330, hardware device 150, now pre-programmed with the private cryptographic key, is sent to an intended recipient of messages. Additional steps may also be taken. For example, one or more public keys belonging to the operator of first computer subsystem 110, or of other parties, may also be pre-programmed on the hardware device 150. In addition, the hardware device may be programmed with a password or passphrase that is required to operate the hardware device 150. This may be done by using another cryptographic key as the password and storing the cryptographic key in an enciphered form. In this way, it is not possible to access the private key on the hardware device 150, regardless of how the device is tampered with, because additional information is required, that information being the passphrase.

In step 340, message is enciphered with the public cryptographic key that was generated in step 310. It should be recognized that the enciphering of the message need not occur subsequent to step 320 or 330, although it may, because the message may be enciphered as long as a key has been generated with which to encipher it. The enciphered message is sent to the hardware device in step 350. And in step 360, the message is deciphered by the data processor 220 using the private cryptographic key stored in the memory 230 on the hardware device 150.

It will be recognized that the messages enciphered and deciphered in the above description using the asymmetric cryptographic key pair may themselves be cryptographic keys, and more specifically they may be session keys. The session keys may be symmetric keys that are used to encipher end decipher the remaining bulk of the transmitted messages. This may be done to increase efficiency, as algorithms for enciphering an deciphering based on symmetric keys may be computed faster than those based on asymmetric keys. However, symmetric keys may lack the public key/private key dichotomy, and therefore may be unsuitable for some applications without the additional use of asymmetric keys.

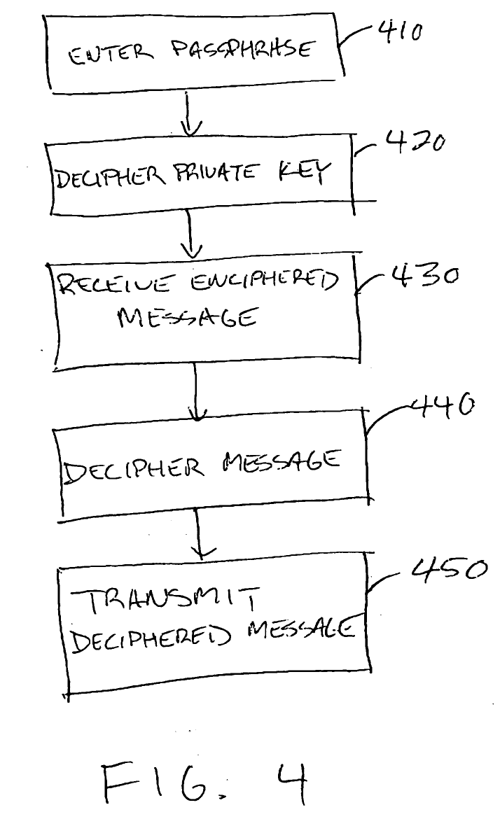

FIG. 4 shows a method for deciphering a message using the hardware device 150. In step 410, the user may enter the passphrase for the hardware device 150. The passphrase may be entered on the second computer subsystem 120 and then transmitted to the device 150, or may be entered in some other manner such as via a keypad that may be provided on the device 150 itself. In step 420, the passphrase is used to decipher the private key. This step may be carried out by the data processor 220 in conjunction with memory 230. In step 430, an enciphered message is received by the hardware device 150. The message may be received from the second computer subsystem 120 after having been transmitted by the first computer subsystem 110 over the transmission path 130. It will be recognized that the message may be received before the passphrase is entered, or at some other time. The message is deciphered by the data processor 220 in step 440. In step 450, the deciphered message may be transmitted to the second computer subsystem 120.

FIG. 5 shows a method for enciphering a message and sending it with a digital signature. In step 510, a hashing algorithm is applied to a message and a hash is generated. The hash may be analogous to a fingerprint of the message, as each message may have a unique hash, which may comprise fewer bits than the corresponding message. The hashing algorithm may be public information so that other parties may also be able to generate the same unique hash. In step 520, the data processor enciphers the hash using the public key. The enciphered hash is then appended to the message in step 530. It is the enciphered hash that is sometimes referred to as a digital signature. In step 540, the message, with the appended enciphered hash, is enciphered with the public key of the intended recipient. The intended recipient may be the operator of the first computer subsystem 110, or some other party, and the public key may or may not be pre-programmed on the cryptographic hardware device 150. The enciphered message, including the twice-enciphered hash, may then be sent to the intended recipient in step 550. For example, the enciphered message, which is an enciphered message with a digital signature, may be sent from the second computer subsystem 120 to the first computer subsystem 110 via the transmission path 130. The intended recipient may then decipher the message first using the recipient's private key. Then, the recipient may decipher the enciphered hash by applying the public key of the sender, which may have been generated in step 310 of FIG. 3. The recipient then may run the public hash algorithm on the deciphered message (without the appended hash) and may compare the hash computed from the message using the hash algorithm to the hash deciphered from the digital signature. If there are congruent hashes, the sender of the message has been authenticated. Furthermore, the recipient of the message cannot forge the digital signature without the sender's private key. This may limit the possibility that the sender would repudiate or deny sending the message by claiming that the digital signature was a fraudulent version created by the recipient or other party.

An example of where the above described apparatus and method may be used is the case of a bank and an account holder. These two parties may wish to exchange sensitive information such as account numbers and balances, debit card PINs, social security numbers, and the like. The account holder's representative may physically visit a bank branch to establish a passphrase for the hardware device 150. The bank may then generate the asymmetric key pair and store it on the hardware device along with any other desired information. The bank may then send the device to the account holder via a common carrier or a courier. The account holder and bank may then use the device 150 as described above. In this way, it is difficult for a third party to fully breach the security measures. The third party would have to intercept the message, would have to physically obtain the device, and would also have to obtain the passphrase. Note that the private key does not ever need to leave the hardware device 150. Thus, even if a hacker is able to access the contents of the account holder's computer, the private key will not be stolen. Also, the problem of authenticating a public key to an intended recipient is solved by the use of the passphrase in combination of the physical sending of the device 150 to a physical address specified by the recipient. This may reduce or eliminate the need for digital certificate authorities and related security concerns.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the claims.

What is claimed is:

1. A cryptographic device comprising:
a memory pre-programmed with a cryptographic key;
a data processor connected to the memory, for deciphering data with the cryptographic key; and
an interface for connecting the data processor to a computer.

2. The cryptographic device of claim 1 wherein the memory is further pre-programmed with another cryptographic key, and wherein the data processor is further programmed to encipher data with the other cryptographic key.

3. The cryptographic device of claim 1 wherein the data processor is programmed to encipher the data to produce a digital signature.

4. The cryptographic device of claim 1 wherein the device is portable.

5. The cryptographic device of claim 4 wherein the interface comprises a USB connection.

6. A method for distributing private keys for use in a public key cryptographic system, the method comprising:
generating an asymmetric key pair comprising a public cryptographic key and a private cryptographic key;
storing the private cryptographic key on a portable hardware device, wherein the portable hardware device comprises a memory for storing the private cryptographic key, a decryption unit for decrypting data with the private cryptographic key, and a physical data connector for connecting the device to a computer;
sending the portable hardware device, with the private cryptographic key stored thereon, to an intended recipient of an encrypted message;
encrypting data with the public cryptographic key, and transmitting the encrypted data to the portable hardware device for decryption of the data by the device.
